(19) United States
(12) Patent Application Publication
(10) Pub. No.: US 2013/0154843 A1
(43) Pub. Date: Jun. 20, 2013

(54) WIRELESS ALERT DEVICE, COMMUNICATION DEVICE AND ALERT METHOD

(71) Applicant: Shao-Ztu LAN, Shindian (TW)

(72) Inventor: Shao-Ztu LAN, Shindian (TW)

(73) Assignee: FIH (Hong Kong) Limited, Kowloon (HK)

(21) Appl. No.: 13/572,658

(22) Filed: Aug. 12, 2012

(30) Foreign Application Priority Data
Dec. 15, 2011 (TW) 100146657

(51) Int. Cl. G08B 21/18

(52) U.S. Cl. 340/686.6

(57) ABSTRACT

A wireless alert device is paired with a communication device and a connection between the wireless alert device and the communication device is established. The wireless alert device continuously emits a first wireless signal, and the communication device continuously emits a second wireless signal. The wireless alert device receives the second wireless signal, calculates a first received signal strength indication (RSSI) value of the second wireless signal, and sends out an alarm when the first RSSI value is less than a preset value. The communication device receives the first wireless signal, calculates a second RSSI value of the first wireless signal, and outputs an alert when the second RSSI value is less than the preset value.

### BACKGROUND

1. Technical Field

The embodiments of the present disclosure relate to alert systems and methods, and particularly to a wireless alert device, a communication device and an alert method.

2. Description of Related Art

Losing your keys or misplacing wallets can be annoying. It is time consuming to look for them and sometimes they might even be lost. Therefore, there is room for improvement in the art.

### BRIEF DESCRIPTION OF THE DRAWINGS

FIG. 1 is a block diagram of one embodiment of function modules of a wireless alert device and a communication device.

FIG. 2 is a flowchart of one embodiment of an alert method.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one”.

In general, the word “module”, as used herein, refers to logic embodied in hardware or firmware, or to a collection of software instructions, written in a programming language. One or more software instructions in the modules may be embedded in firmware, such as in an erasable programming read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

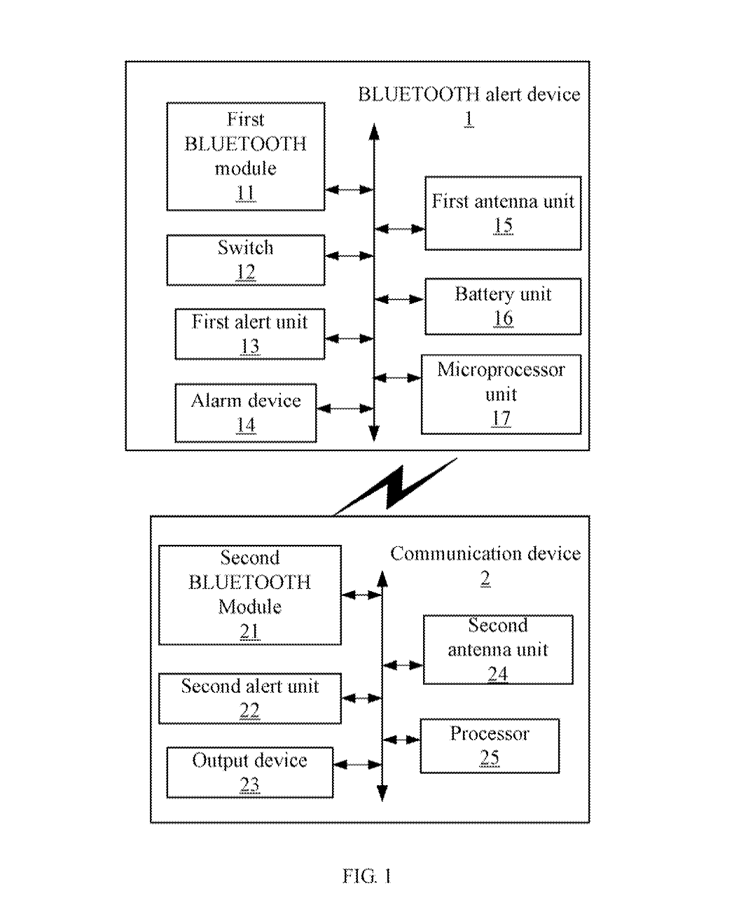

FIG. 1 is a block diagram of one embodiment of function modules of a wireless alert device 1 and a communication device 2. The wireless alert device 1 may be installed on or within objects, such as clothes/shoes worn by people, in bags or wallets, for example. The wireless alert device 1 on or within the objects may be detachable or non-detachable. For example, the wireless alert device 1 may be fixed on an object, or be stuck to or clamped to or suspended from or put on/within the object.

In one embodiment, the wireless alert device 1 includes a first wireless communication module 11, a switch 12, a first alert unit 13, an alarm device 14, a first antenna unit 15, a battery unit 16, and microprocessor unit 17. The first wireless communication module 11 may be a BLUETOOTH module, for example. The switch 12 controls power-on and power-off operations of the wireless alert device 1 by turning on or turning off the battery unit 16. In this embodiment, when the wireless alert device 1 is powered on, the first wireless communication module 11 is switched on.

In this embodiment, the first alert unit 13 includes computerized instructions that are executed by the microprocessor unit 17 to provide below mentioned functions. For example, after the wireless alert device 1 has paired with the communication device 2 and established a connection with the communication device 2, the first alert unit 13 activates the first antenna unit 15 to continuously emit a first wireless signal and to receive a second wireless signal emitted by the communication device 2. The first wireless signal and the second wireless signal may be BLUETOOTH signal, for example. The first alert unit 13 then calculates a received signal strength indication (RSSI) value of the second wireless signal, and determines whether a distance between the wireless alert device 1 and the communication device 2 exceeds a preset distance (such as 10 meters) by determining whether the RSSI value of the second wireless signal is less than a preset value. For example, the preset value may be 0. In this embodiment, if the RSSI value of the second wireless signal is less than the preset value, the distance between the wireless alert device 1 and the communication device 2 is determined as exceeding the preset distance, and the first alert unit 13 activates the alarm device 14 to send out an alarm. Depending on the embodiment, the alarm device 14 may include, but is not limited to, a buzzer, an illuminant, a vibrator, or other device that can send out sounds, lights, vibrations, or other indication signals.

The components 11-17 of the wireless alert device 1 communicate with each other via a bus. One skilled in the art knows that the wireless alert device 1 may be configured in a number of other ways and may include other or different components. For example, the wireless alert device 1 may further include a display screen (not shown), which can display battery power information of the battery unit 16 and display alert information, such as “Notice! You have gone out of the safe distance! Please come back!” when the distance between the wireless alert device 1 and the communication device 2 exceeds the preset distance.

The communication device 2 includes a second wireless communication module 21, a second alert unit 22, an output device 23, a second antenna unit 24, and a processor 25. The components 21-25 communicate with each other via a bus. One skilled in the art knows that the communication device 2 may be configured in a number of other ways and may include other or different components. Depending on the embodiment, the communication device 2 may be a mobile phone, a personal digital assistant, a portable computer, or other suitable electronic device. The second wireless communication module 21 may be a BLUETOOTH signal, for example.

In this embodiment, the second alert unit 22 includes computerized instructions that are executed by the processor unit 25 to provide below mentioned functions. For example, after the communication device 2 has paired with the wireless alert device 1 and established the connection with the wireless alert device 1, the second alert unit 22 activates the second antenna unit 24 to continuously emit the second wireless signal and to receive the first wireless signal emitted by the wireless alert device 1. The second alert unit 22 then calculates a RSSI value of the first wireless signal, and determines whether the distance between the wireless alert device 1 and the communication device 2 exceeds the preset distance by determining whether the RSSI value of the first wireless signal is less than the preset value. If the distance between the wireless alert device 1 and the communication device 2 exceeds the preset distance, the second alert unit 22 activates the output device 23 to output alert information. In this embodiment, the output device 23 may include a display screen and a speaker. The alert information may include a text format that can be displayed on the display and a sound format that can be given audibly via the speaker.

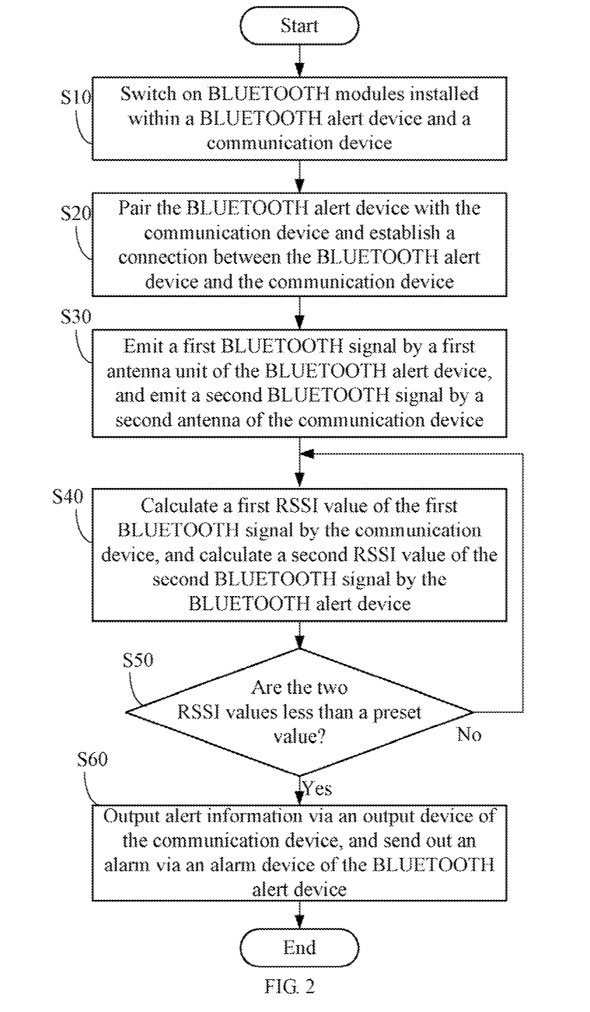

FIG. 2 is a flowchart of one embodiment of an alert method. Depending on the embodiment, additional blocks may be added, others removed, and the ordering of the blocks may be changed.

In step S10, the first wireless communication module 11 of the wireless alert device 1 and the second wireless communication module 21 of the communication device 2 are switched on. In this embodiment, when the wireless alert device 1 is powered on, the first wireless communication module 11 is switched on. The second wireless communication module 21 may be switched on by selecting a “turning on BLUETOOTH” option under a “settings” menu of the communication device.

In step S20, pairing the wireless alert device 1 with the communication device 2 and establishing a connection between the wireless alert device 1 and the communication device 2. For example, after the second wireless communication module 21 has been switched on, a “scanning for BLUETOOTH devices” option of the “settings” menu may be selected to search for available BLUETOOTH devices. All discovered BLUETOOTH devices will be listed and displayed on the display screen of the communication device, then a user may select the wireless alert device 1 to establish the pairing and connection relationship between the wireless alert device 1 and the communication device 2.

In step S30, the first alert unit 13 activates the first antenna unit 15 to continuously emit a first wireless signal, and the second alert unit 22 activates the second antenna unit 24 to continuously emit a second wireless signal.

In step S40, the first alert unit 13 calculates an RSSI value of the second wireless signal, and the second alert unit 22 calculates an RSSI value of the first wireless signal.

In step S50, the first alert unit 13 determines whether a distance between the wireless alert device 1 and the communication device 2 exceeds a preset distance (such as 10 meters) by determining whether the RSSI value of the second wireless signal is less than a preset value (such as 0). The second alert unit 22 determines whether the distance between the wireless alert device 1 and the communication device 2 exceeds the preset distance by determining whether the RSSI value of the first wireless signal is less than the preset value. When the RSSI value of the first wireless signal or the RSSI value of the second wireless signal is less than the preset value, the distance between the wireless alert device 1 and the communication device 2 is determined as exceeding the preset distance, and step S60 is performed. Otherwise, when each of the two RSSI values is equal to or more than the preset value, the distance between the wireless alert device 1 and the communication device 2 is determined as falling within the preset distance, and the procedure returns to S40.

In step S60, the first alert unit 13 activates the alarm device 14 to send out an alarm when the RSSI value of the second wireless signal is less than the preset value. As mentioned above, the alarm device 14 may be a buzzer, an illuminant, a vibrator, or other device that can send out sound, light, or other indication signal. The second alert unit 22 activates the output device 23 to output alert information when the RSSI value of the first wireless signal is less than the preset value. The output device 23 may include a display screen and a speaker. The alert information may include a text format that can be displayed on the display and a sound format that can be given audibly via the speaker.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A wireless alert device comprising:
a microprocessor unit;
a first wireless communication module that pairs the wireless alert device with a communication device having a second wireless communication module and establishes a connection between the wireless alert device and the communication device;
a first alert unit storing computerized instructions that are executed by the microprocessor unit to perform operations of:
calculating a received signal strength indication (RSSI) value of a wireless signal that is emitted by the communication device and received by a first antenna unit of the wireless alert device;
determining whether a distance between the wireless alert device and the communication device exceeds a preset distance by determining whether the RSSI value of the received wireless signal is less than a preset value; and
informing users of the wireless alert device and the communication device that the distance between the wireless alert device and the communication device exceeds the preset distance by activating an alarm device of the wireless alert device to send out an alarm when the RSSI value of the received wireless signal is less than the preset value.

2. The wireless alert device of claim 1, wherein the wireless alert device is installed to an object via a detachable manner or a non-detachable manner.

3. The wireless alert device of claim 1, wherein the alarm device is one or more selected from the group of a buzzer, an illuminant, and a vibrator.

4. The wireless alert device of claim 3, wherein the alarm is one or more selected from the group of sound, light, and vibration.

5. A communication device comprising:
a processor;
a second wireless communication module that pairs the communication device with a wireless alert device having a first wireless communication module and establishes a connection between the communication device and the wireless alert device;
a second alert unit storing computerized instructions that are executed by the processor to perform operations of:
calculating a received signal strength indication (RSSI) value of a wireless signal that is emitted by the wireless alert device and received by a second antenna unit of the communication device;
determining whether a distance between the wireless alert device and the communication device exceeds a preset distance by determining whether the RSSI value of the received wireless signal is less than a preset value; and
informing users of the wireless alert device and the communication device that the distance between the wireless alert device and the communication device exceeds the preset distance by activating an output device of the communication device to output alert information when the RSSI value of the received wireless signal is less than the preset value.

6. The communication device of claim 5, wherein the communication device is a mobile phone, a personal digital assistant, or a portable computer.

7. The communication device of claim 5, wherein the output device is a display screen or a speaker.

8. The communication device of claim 7, wherein the alert information is in a text format or a sound format.

9. An alert method being executed by a microprocessor unit of a wireless alert device, the wireless alert device having been paired with a communication device and a connection between the wireless alert device and the communication device having been established, the method comprising:
calculating a received signal strength indication (RSSI) value of a wireless signal that is emitted by the communication device and received by a first antenna unit of the wireless alert device;
determining whether a distance between the wireless alert device and the communication device exceeds a preset distance by determining whether the RSSI value of the received wireless signal is less than a preset value; and
informing users of the wireless alert device and the communication device that the distance between the wireless alert device and the communication device exceeds the preset distance by activating an alarm device of the wireless alert device to send out an alarm when the RSSI value of the received wireless signal is less than the preset value.

10. The alert method of claim 9, wherein the wireless alert device is installed to an object via a detachable manner or a non-detachable manner.

11. The alert method of claim 9, wherein the alarm device is one or more selected from the group of a buzzer, an illuminant, and a vibrator.

12. The alert method of claim 11, wherein the alarm is one or more selected from the group of sound, light, and vibration.

13. An alert method being executed by a processor unit of a communication device, the communication device having been paired with a wireless alert device and a connection between the wireless alert device and the communication device having been established, the method comprising:
calculating a received signal strength indication (RSSI) value of a wireless signal that is emitted by the wireless alert device and received by a second antenna unit of the communication device;
determining whether a distance between the wireless alert device and the communication device exceeds a preset distance by determining whether the RSSI value of the received wireless signal is less than a preset value; and
informing users of the wireless alert device and the communication device that the distance between the wireless alert device and the communication device exceeds the preset distance by activating an output device of the communication device to output alert information when the RSSI value of the received wireless signal is less than the preset value.

14. The alert method of claim 13, wherein the communication device is a mobile phone, a personal digital assistant, or a portable computer.

15. The alert method of claim 13, wherein the output device is a display screen or a speaker.

16. The alert method of claim 15, wherein the alert information is in a text format or a sound format.
